(19) United States
(12) Patent Application Publication
(10) Pub. No.: US 2024/0242146 A1
(43) Pub. Date: Jul. 18, 2024

(54) METHOD AND SYSTEM FOR SMART LIQUIDITY MANAGEMENT

(71) Applicant: JPMorgan Chase Bank, N.A., New York, NY (US)

(72) Inventors: Neha SHETE, Hyderabad (IN); Niti SHAH, Mumbai (IN); Charmi KHAMBHATI, Ankleshwar (IN); Amar JAIN, Mumbai (IN); Prashant BAJ, Pune (IN)

(73) Assignee: JPMorgan Chase Bank, N.A., New York, NY (US)

(21) Appl. No.: 18/134,196

(22) Filed: Apr. 13, 2023

(30) Foreign Application Priority Data
Jan. 14, 2023 (IN) 202311002947

(51) Int. Cl. G06Q 10/0631; G06Q 40/12

(52) U.S. Cl. CPC G06Q 10/06315; G06Q 40/12

(57) ABSTRACT

A method for smart liquidity management is disclosed. The method includes: receiving a past transactional data set comprising data of at least one transaction; identifying a first set of parameters and a second set of parameters based on the past transactional data set; analyzing the first set of parameters, to automatically predict an amount receivable for an acquirer bank entity from at least one card network, for a period of time; analyzing the second set of parameters, to automatically predict an amount payable from the acquirer bank entity to at least one merchant, for the period of time; and identifying a smart liquidity plant for the acquirer bank entity based on the prediction of the amount receivable and the prediction of the amount payable. The smart liquidity plan comprises at least one liquidity demand, and each liquidity demand corresponds to a specific currency type.

### CROSS-REFERENCE TO RELATED APPLICATIONS

This application claims priority benefit from Indian Application No. 202311002947, filed Jan. 14, 2023 in the Indian Patent Office, which is hereby incorporated by reference in its entirety.

### BACKGROUND

### Field of the Disclosure

This technology generally relates to methods and systems for smart liquidity management and particularly to methods and systems for automatically assessing the upcoming liquidity needs of an institution.

### Background Information

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Typically, acquiring banks end up keeping a surplus, or liquidity amount, in bank accounts to ensure smooth prefunding to merchants. An acquiring bank's ability to grow internationally is hampered by the overhead of manual calibration for prefunding in various regions and currencies, which is added by the clearing houses and payment networks like Visa, MasterCard, etc. in most cases within 2 days. Making proactive or accelerated payments to the bank's preferred merchants is difficult because this manual management of funds is not efficient. As a result of the large number of clearing houses, the number of merchants, and the variety of currencies involved, this process becomes incredibly complicated.

Further, due to the risk of liquidity, there are strict guidelines for the mobility of the banking system in every nation and region. Banks will receive the appropriate punishment, and some banks may even cease operations. Banks must therefore manage mobility thoroughly. As a result, supervision faces a trade-off between being sanctioned and having to forecast the next fund state in order to address liquidity quickly.

In the prior art, various flexible liquidity management mechanisms, such as fund pools, are provided for system participants (the system participants refer to various commercial banks), but the liquidity management mechanisms are not completely open to the participants due to the limitations of various factors. The liquidity of a clearing account set up by a participant in a payment system is mainly used for clearing and using the services of the participant in a large payment system, a small payment system, and an online cross-bank clearing system. At present, in the operation of the system, it is found that the participant lacks an accurate grasp on the amount of money required by the participant to complete the clearing service every day, which causes liquidity waste on the part of the participant's clearing account and cannot generate a higher economic benefit. Thus, there exists a need to develop a system to predict the liquidity requirement for a clearing service effectively, and adequately, in a timely manner in order to enable the smooth management of funds.

### SUMMARY

The present disclosure, through one or more of its various aspects, embodiments, and/or specific features or sub-components, provides, inter alia, various systems, servers, devices, methods, media, programs, and platforms for predicting a smart liquidity plan for an acquirer bank entity based on a prediction of an amount receivable and a prediction of an amount payable.

According to an aspect of the present disclosure, a method for smart liquidity management is disclosed. The method comprises: receiving, by at least one processor, a past transactional data set comprising data of at least one transaction; identifying, by the at least one processor, a first set of parameters and a second set of parameters based on the past transactional data set; analyzing, by the at least one processor, the first set of parameters, to automatically predict an amount receivable for an acquirer bank entity from at least one card network, for a period of time; analyzing, by the at least one processor, the second set of parameters, to automatically predict an amount payable from the acquirer bank entity to at least one merchant, for the period of time; and identifying, by the at least one processor, a smart liquidity plan for the acquirer bank entity based on the prediction of the amount receivable and the prediction of the amount payable.

In accordance with an exemplary embodiment, the past transactional data set may further comprise at least one set of transactional parameters associated with each transaction from among the at least one transaction, wherein the at least one set of transactional parameters may include an amount, a date, a day of week, occasional event data, a merchant, a currency, and a region.

In accordance with an exemplary embodiment, the first set of parameters may include the at least one card network, a settlement history of a corresponding card network, a currency, a region, and a total transaction amount for the corresponding card network based on at least one from among a date, a day of the week, and a special occasion.

In accordance with an exemplary embodiment, the second set of parameters may include the at least one merchant, a transaction history of a corresponding merchant, a currency, a region, and a total transaction amount for the corresponding merchant based on at least one from among a date, a day of the week, and a special occasion.

In accordance with an exemplary embodiment, the smart liquidity plan may include at least one liquidity demand, wherein each liquidity demand corresponds to a specific currency type.

According to another aspect of the present disclosure, a computing device for smart liquidity management is disclosed. The computing device comprises a processor, a memory, and a communication interface coupled to each of the processor and the memory. Further, the processor is configured to: receive, via the communication interface, at least one past transactional data set comprising data of at least one transaction, identify a first set of parameters and a second set of parameters based on the received at least one past transactional data set, analyze the first set of parameters, to automatically predict an amount receivable for an acquirer bank entity from at least one card network, for a period of time, analyze the second set of parameters, to automatically predict an amount payable from the acquirer bank entity to at least one merchant, for the period of time, and identify a smart liquidity plan for the acquirer bank entity based on the prediction of the amount receivable and the prediction of the amount payable.

In accordance with an exemplary embodiment, the at least one past transactional data set may further comprise at least one set of transactional parameters associated with each transaction from among the at least one transaction, wherein the at least one set of transactional parameters may include an amount, a date, a day of week, occasional event data, a merchant, a currency, and a region.

In accordance with an exemplary embodiment, the first set of parameters may include the at least one card network, a settlement history of a corresponding card network, a currency, a region, and a total transaction amount for the corresponding card network based on at least one from among a date, a day of the week, and a special occasion.

In accordance with an exemplary embodiment, the second set of parameters may include the at least one merchant, a transaction history of a corresponding merchant, a currency, a region, and a total transaction amount for the corresponding merchant based on at least one from among a date, a day of the week, and a special occasion.

In accordance with an exemplary embodiment, the smart liquidity plan may include at least one liquidity demand, wherein each liquidity demand corresponds to a specific currency type.

According to yet another aspect of the present disclosure, a non-transitory computer readable storage medium storing instructions for smart liquidity management is disclosed. The instructions include executable code which, when executed by a processor, may cause a processor to: receive a past transactional data set comprising data of at least one transaction, identify a first set of parameters and a second set of parameters based on the received past transactional data set, analyze the first set of parameters, to automatically predict an amount receivable for an acquirer bank entity from at least one card network, for a period of time, analyze the second set of parameters, to automatically predict an amount payable from the acquirer bank entity to at least one merchant, for the period of time, and identify a smart liquidity plan for the acquirer bank entity based on the prediction of the amount receivable and the prediction of the amount payable.

In accordance with an exemplary embodiment, the past transactional data may further include at least one set of transactional parameters associated with each transaction of the at least one transaction, wherein the at least one set of transactional parameters may include an amount, a date, a day of week, occasional event data, a merchant, a currency, and a region.

In accordance with an exemplary embodiment, the first set of parameters may include the at least one card network, a settlement history of a corresponding card network, a currency, a region, and a total transaction amount for the corresponding card network based on at least one from among a date, a day of the week, and a special occasion.

In accordance with an exemplary embodiment, the second set of parameters may include the at least one merchant, a transaction history of a corresponding merchant, a currency, a region, and a total transaction amount for the corresponding merchant based on at least one from among a date, a day of the week, and a special occasion.

In accordance with an exemplary embodiment, the smart liquidity plan may include at least one liquidity demand, wherein each liquidity demand corresponds to a specific currency type.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary computer system for predicting a smart liquidity plan in accordance with an exemplary embodiment.

FIG. 2 illustrates an exemplary diagram of a network environment for predicting a smart liquidity plan in accordance with an exemplary embodiment.

FIG. 3 shows an exemplary system for implementing a method for predicting a smart liquidity plan, in accordance with an exemplary embodiment.

FIG. 4 is a flowchart of an exemplary process for implementing a method for predicting a smart liquidity plan, in accordance with an exemplary embodiment.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases/terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different.

In addition, all logical units/controller described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the invention. It will be apparent however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

To overcome the problems associated with the identification of liquidity requirements for cost and performance optimization, the present disclosure provides a method and system for predicting a liquidity plan. The apparatus or system first receives a past transactional data set comprising data for one or more transactions. The past transactional data further comprises one or more transaction parameters associated with each transaction of the one or more transactions, wherein the one or more transaction parameters comprise of an amount, a date, a day of the week, occasional event data, a merchant, a currency, and a region. Further, the system comprises identifying a first set of parameters and a second set of parameters based on the past transactional data set. Further, the system analyzes the first set of parameters to automatically predict an amount receivable for an acquirer bank entity from one or more card networks for a period of time. The first set of parameters includes one or more card networks, a settlement history of the corresponding card network, a currency, a region, and a total transaction amount for the corresponding card network based on at least one of a date, a day of the week, and a special occasion. The system further analyzes the second set of parameters to automatically predict an amount payable from the acquirer bank entity to one or more merchants for the period of time, wherein the second set of parameters further comprises the one or more merchants, a transaction history of the corresponding merchant, a currency, a region, and a total transaction amount for the corresponding merchant based on at least one of a date, a day of the week, and a special occasion. Further, the system identifies a smart liquidity plan for the acquirer bank entity based on the prediction of the amount receivable and the prediction of the amount payable, wherein the smart liquidity plan comprises one or more liquidity demands, wherein each liquidity demand corresponds to a specific currency type.

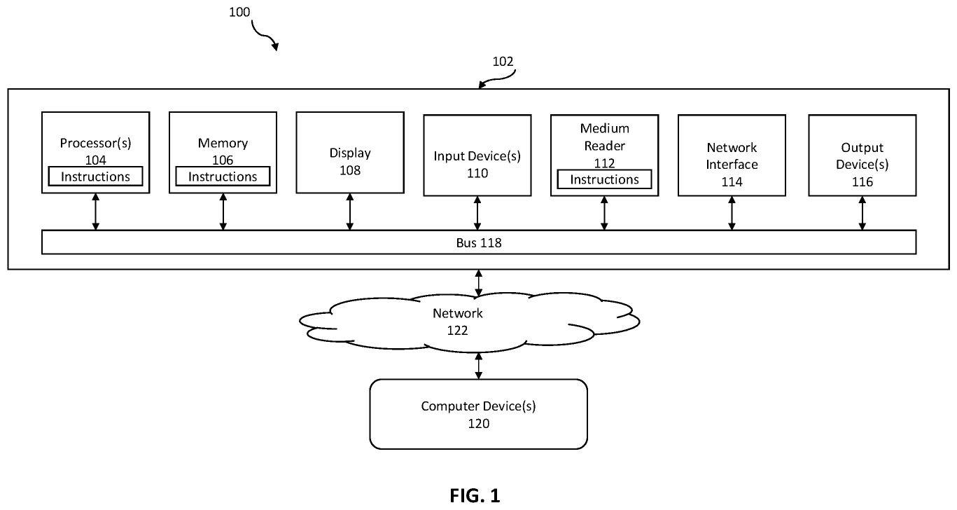

FIG. 1 is an exemplary system for use in accordance with the embodiments described herein. The system 100 is generally shown and may include a computer system 102, also known as computing device 102, which is generally indicated to predict a liquidity plan.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. As regards the present invention, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses. Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for predicting a liquidity plan based on an execution of one or more instructions.

As described herein, various embodiments provide optimized methods and systems for predicting liquidity plan and recommending an amount to be maintained by the acquirer bank based on the amount receivable for an acquirer bank entity from one or more card networks and an amount payable from the acquirer bank entity to the one or more merchants, for a period of time.

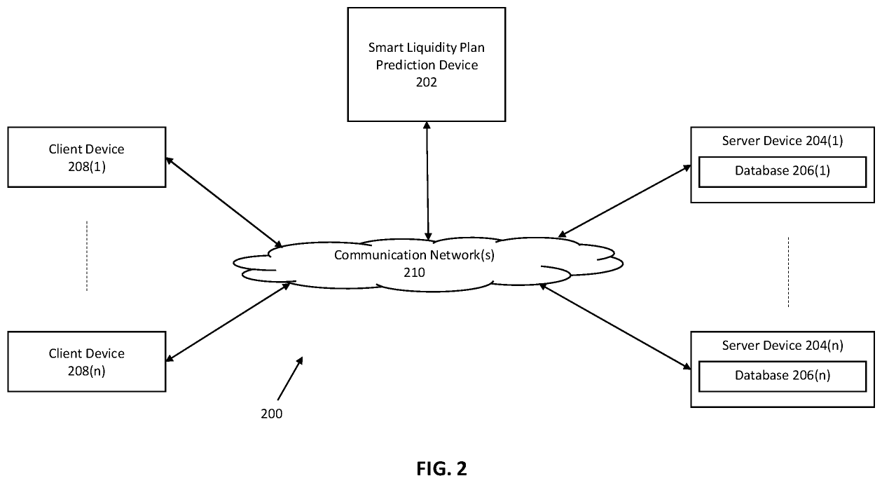

Referring to FIG. 2, a schematic of an exemplary network environment 200 for implementing a method for predicting a liquidity plan is illustrated in accordance with an exemplary embodiment. In an exemplary embodiment, the method is executable on any networked computer platform, such as, for example, a personal computer (PC).

The method for predicting a liquidity plan may be implemented by a Smart Liquidity Plan Prediction (SLPP) device 202. The SLPP device 202 may be the same or similar to the computer system 102 as described with respect to FIG. 1. The SLPP device 202 may store one or more applications that can include executable instructions that, when executed by the SLPP device 202, cause the SLPP device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SLPP device 202 itself, may be located in virtual server(s) running in a cloud-based computing environment rather than being tied to one or more specific physical network computing devices. Also, the application(s) may be running in one or more virtual machines (VMs) executing on the SLPP device 202. Additionally, in one or more embodiments of this technology, virtual machine(s) running on the SLPP device 202 may be managed or supervised by a hypervisor.

In the network environment 200 of FIG. 2, the SLPP device 202 is coupled to a plurality of server devices 204(1)-204(n) that hosts a plurality of databases 206(1)-206(n), and also to a plurality of client devices 208(1)-208(n) via communication network(s) 210. A communication interface of the SLPP device 202, such as the network interface 114 of the computer system 102 of FIG. 1, operatively couples and communicates between the SLPP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SLPP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and SLPP devices that efficiently implement a method for predicting a liquidity plan, the method being implemented by at least one processor.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SLPP device 202 may be a standalone device or integrated with one or more other devices or apparatuses, such as one or more of the server devices 204(1)-204(n), for example. In one particular example, the SLPP device 202 may include or be hosted by one of the server devices 204(1)-204(n), and other arrangements are also possible. Moreover, one or more of the devices of the SLPP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SLPP device 202 via the communication network(s) 210 according to the HTTP-based and/or JavaScript Object Notation (JSON) protocol, for example, although other protocols may also be used.

The server devices 204(1)-204(n) may be hardware or software, or they may represent a system with multiple servers in a pool, which may include internal or external networks. The server devices 204(1)-204(n) host the databases 206(1)-206(n) that are configured to store historical data related to the past transactions hosted at the host platform, other transactional details of the one or more transactions hosted at the host platform, card network settlement history data, merchant transaction history data after using the liquidity as was predicted by the system in the past, etc.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the SLPP device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the SLPP device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the SLPP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SLPP device 202, the server devices 204(1)-204(n), or the client devices 208(1)-208(n), for example, may be configured to operate as virtual instances on the same physical machine. In other words, one or more of the SLPP device 202, the server devices 204(1)-204(n), or the client devices 208(1)-208(n) may operate on the same physical device rather than as separate devices communicating through communication network(s) 210. Additionally, there may be more or fewer SLPP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

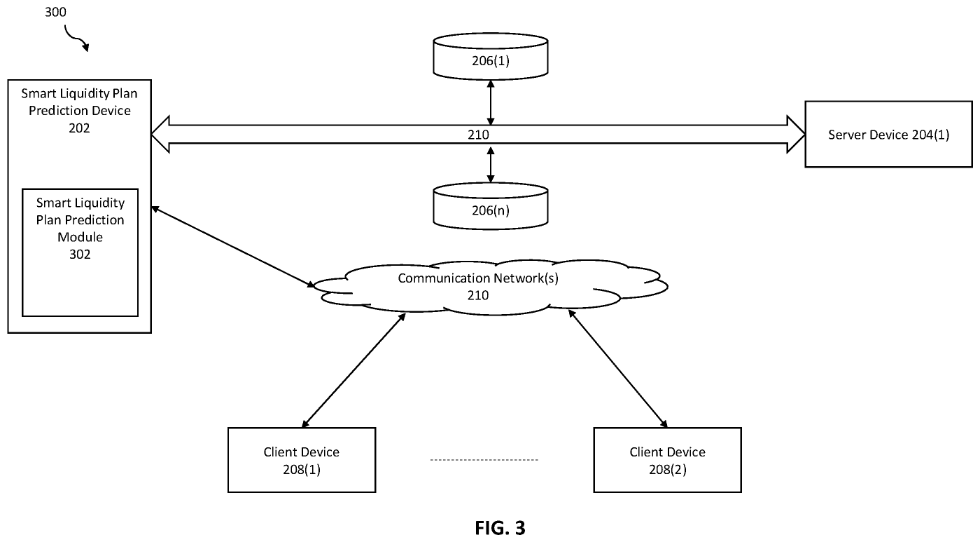

FIG. 3 illustrates an exemplary system for implementing a method for predicting a liquidity plan based on an amount receivable for an acquirer bank entity and an amount payable from the acquirer bank entity, in accordance with an exemplary embodiment. As illustrated in FIG. 3, according to exemplary embodiments, the system 300 may comprise an SLPP device 202 including an SLPP module 302 that may be connected to a server device 204(1) and one or more repository 206(1) . . . 206(n) via a communication network 210, but the disclosure is not limited thereto.

The SLPP device 202 is described and shown in FIG. 3 as including Smart Liquidity Plan Prediction (SLPP) Module 302, although it may include other rules, policies, modules, databases, or applications, for example. As will be described below, the Smart Liquidity Plan Prediction (SLPP) Module 302 is configured to implement a method for predicting a liquidity plan.

An exemplary process 300 for implementing a mechanism for predicting a liquidity plan based on an amount receivable for an acquirer bank entity and an amount payable from the acquirer bank entity by utilizing the network environment of FIG. 2 is shown as being executed in FIG. 3. Specifically, a first client device 208(1) and a second client device 208(2) are illustrated as being in communication with SLPP device 202. In this regard, the first client device 208(1) and the second client device 208(2) may be “clients” of the SLPP device 202 and are described herein as such. Nevertheless, it is to be known and understood that the first client device 208(1) and/or the second client device 208(2) need not necessarily be “clients” of the SLPP device 202, or any entity described in association therewith herein. Any additional or alternative relationship may exist between either or both of the first client device 208(1) and the second client device 208(2) and the SLPP device 202, or no relationship may exist.

Further, SLPP device 202 is illustrated as being able to access the one or more repositories 206(1) . . . 206(n). The SLPP module 302 may be configured to access these repositories/databases for implementing a method for predicting a liquidity plan based on the prediction of the amount receivable and the amount payable.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the SLPP device 202 via broadband or cellular communication. Of course, these embodiments are merely exemplary and are not limiting or exhaustive.

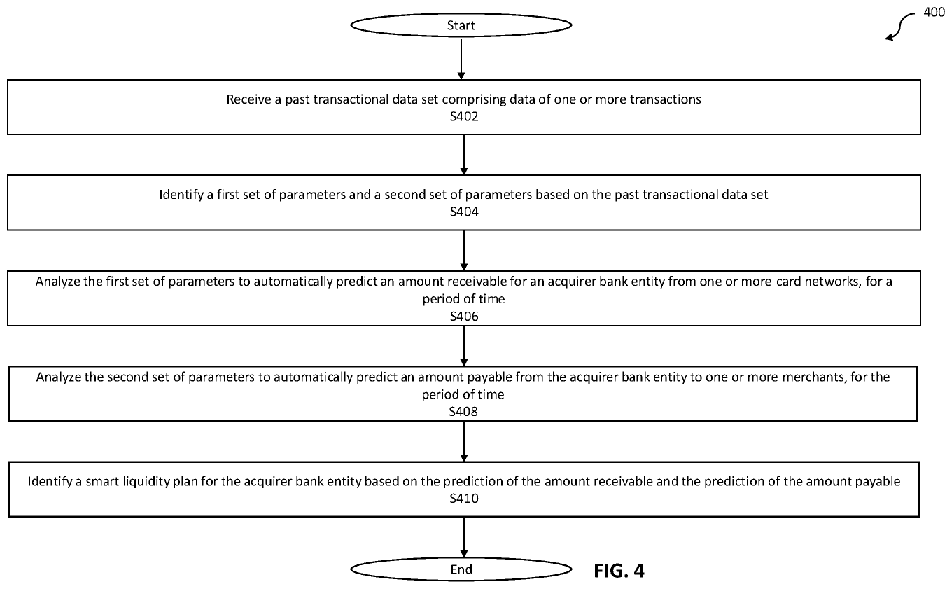

Referring to FIG. 4, an exemplary method is shown for predicting a liquidity plan, in accordance with exemplary embodiment of the present disclosure. As shown in FIG. 4, the method begins at step S402 following the receipt of a past transactional data set comprising data of one or more transactions. As disclosed by the present disclosure, the past transactional data further comprises one or more transactions parameters associated with each transaction of the one or more transactions. The one or more transaction parameters may include but are not limited to, an amount, a date, a day of week, occasional event data, a merchant, a currency, and a region. In an implementation of the present invention, the past transactional data may be grouped together for a particular merchant, and/or for a card network which might further be segregated for a particular merchant or card network based on the day of the week or month or currency or any other parameter. For this purpose, in a non-limiting embodiment, the system 100 may implement a Vector Autoregression regression (VAR) model. For this purpose, in a non-limiting embodiment, the past transactional data set may already be stored in one of the databases 206(1)-206(n), and may accordingly be fetched by the at least one processor 104 when required.

After analyzing the past transactional data, at step S404, the processor 104 identifies a first set of parameters and a second set of parameters based on the past transactional data set. In a non-limiting embodiment, the first set of parameters further comprises one or more card networks, a settlement history of the corresponding card network, a currency, a region, and a total transaction amount for the corresponding card network based on at least one of a date, a day of the week, and a special occasion. For instance, let's assume there are 3 card networks (A, B, and C) and each of them has a different timeline for settlement. For example, card network A, B, and C might settle a transaction amount for a transaction day T in T+1 day, T+2 days, and T+3 days respectively. Furthermore, the average transaction amount for card networks A, B, and C is 2 billion USD, 3 billion USD, and 4 billion USD, respectively. Furthermore, these transaction amounts have been distributed among several currencies (USD, INR, and SGD). For the purpose of illustration, let's assume the transaction amount for card network A is distributed as 40% in USD, 40% in INR, and 20% in SGP. Similarly, the total transaction amount for card network B and card network C is distributed as 30% in USD, 45% in INR, and 25% in SGD. In an exemplary implementation of the present invention, the liquidity that an acquirer bank has to maintain will depend on the currency of the transaction amount.

Further, in a non-limiting embodiment, the second set of parameters further comprises data for one or more merchants, a transaction history of the corresponding merchant, a currency, a region, and a total transaction amount for the corresponding merchant based on at least one of a date, a day of the week, and a special occasion. For instance, let's assume there are 3 merchants X, Y, and Z, and each of them has a transaction history. For example, merchants X, Y, and Z might have different transaction amounts for a transaction day T, which is a weekday or a weekend, such as 1 billion USD, 2 billion USD, and 3 billion USD for weekdays, i.e., Monday to Friday, and 4 billion USD, 5 billion USD, and 6 billion USD for weekends, i.e., Saturday and Sunday. Further, the amount of transaction for a corresponding merchant based on the past transaction history of the merchant may be distributed among different currencies such as USD, INR, and SGD. Further, merchant X may be located in New York, merchant Y may be located in Delhi, and merchant Z may be located in Singapore. In an implementation of the present invention, based on the region of the merchant, the currency of the transaction may vary accordingly. A person skilled in the art would appreciate that these parameters are exemplary and do not restrict the disclosure in any possible manner.

Further, at step S406, the method comprises analyzing, by at least one processor, the first set of parameters, to automatically predict an amount receivable for an acquirer bank entity from one or more card networks, for a period of time. For this purpose, the at least one processor may implement a Vector Regressor (VAR) model, as already known in the current state of the art, that will predict an amount receivable for an acquirer bank entity. So, in this step S406, the processor analyzes the first set of parameters, which may include but is not limited to, one or more card networks, a settlement history of a corresponding card network, a currency, a region, and a total transaction amount for the corresponding card network based on at least one of a date, a day of the week, and a special occasion to determine the amount that the acquirer bank is eligible to receive from the various card networks based on the transaction amount and the settlement period of the respective card as discussed above in step S404. For the ease of reference, continuing from the above example, assume that the transaction is occurring over the period of 5 days, wherein timeline for settlement of transaction amount by card network A, B and C for the transaction occurring on transaction day T in T+1 day, T+2 days, and T+3 days respectively.

Further, the total amount receivable by the acquirer bank (TAR) may be further distributed among various currencies based on at least one of the currency of transaction and the region of the transaction. A person skilled in the art would appreciate that these parameters are exemplary and do not restrict the disclosure in any possible manner.

At step S408, the method comprises analyzing, by at least one processor, the second set of parameters, to automatically predict an amount payable from the acquirer bank entity to one or more merchants for the period of time. For this purpose, the at least one processor may implement a Vector Regressor (VAR) model, as already known in the current state of the art, that will predict an amount payable from the acquirer bank entity. So, in this step S408, the processor analyzes the set of second parameters, wherein the set of second parameters comprises, but is not limited to, data related to one or more merchants, a transaction history of the corresponding merchant, a currency, a region, and a total transaction amount for the corresponding merchant based on at least one of a date, a day of the week, and a special occasion to determine the amount that the acquirer bank is eligible to pay to the various merchants based on the transaction amount for the respective merchant for the respective day as discussed above in step S404. For ease of reference, let's assume the transaction amount for merchant X, merchant Y, and merchant Z for the transaction, which is occurring over the period of 5 days and wherein the merchants X, Y, and Z are

| | Total | | Total | | Total | | Total Amount | |
|---|---|---|---|---|---|---|---|---|
| Trans- | Transaction | | Transaction | | Transaction | | Payable by the | |
| action | amount for | | amount for | | amount for | | acquirer bank. | |
| Day (T) | X in USD | | Y in USD | | Z in USD | | (TAP = X + Y + Z) | |
| T | 1 | billion | 1 | billion | 2 | billion | 4 | billion |
| T + 1 | 2 | billion | 1 | billion | 2 | billion | 5 | billion |
| T + 2 | 1.5 | billion | 1.5 | billion | 1 | billion | 4 | billion |
| T + 3 | 3 | billion | .5 | billion | 2.5 | billion | 6 | billion |
| T + 4 | 2 | billion | 1 | billion | 1 | billion | 4 | billion |
| T + 5 | 4 | billion | 1 | billion | 1 | billion | 6 | billion |

located in the same region and transactions are occurring in the same currency, i.e., USD, is as follows.

Furthermore, the total amount payable by the acquirer bank (TAP) may be distributed among different currencies based on at least one of the transaction's currencies or the merchant's region. In an exemplary implementation of the present invention, one region may consist of several merchants and several card networks operating in that region. Furthermore, as revealed by the current disclosure, the total amount of transactions in a specific region across all networks may equal the total number of transactions for all merchants in that region. A person skilled in the art would appreciate that these parameters are exemplary and do not restrict the disclosure in any possible manner.

Further, based on the analysis of the first and the second parameters, at step S406 and step S408 respectively, at step S410, the method includes identifying, by at least one processor, a smart liquidity plan for the acquirer bank entity based on the prediction of the amount receivable and the prediction of the amount payable. Thus, at step S410, the processor is configured to predict the smart liquidity plan. As disclosed by the present disclosure, the smart liquidity plan comprises one or more liquidity demands, wherein each liquidity demand corresponds to a specific currency type. The liquidity demand in a specific currency corresponds to the amount that the acquirer bank needs to maintain in order to settle all the possible transactions for merchants on a given day. For ease of understanding, let's take forward the example discussed above at steps S406 and S408, wherein the total amount receivable (TAR) by the acquirer bank from the various card networks and the total amount payable (TAP) by the acquirer bank to the merchant were determined in USD based on the analysis of the first and second parameters. Now, at step S410, the processor automatically predicts the liquidity amount for the given or forthcoming day/s based on the analysis by the processor at steps S406 and S408 as follows.

| | Total Amount | Total Amount | |
|---|---|---|---|
| Trans- | receivable by | Payable by the | Smart Liquidity Plan |
| action | the acquirer | acquirer bank. | (SLP = TAP − TAR) in |
| Day (T) | bank. (TAR) | (TAP = X + Y + Z) | USD |
| T | 0 billion | 4 billion | 4 billion |
| T + 1 | 0 billion | 5 billion | 3 billion |
| T + 2 | 2 billion | 4 billion | 0 billion |
| T + 3 | 6 billion | 6 billion | 1 billion |
| T + 4 | 8 billion | 4 billion | (−)2 billion (overflow) |
| T + 5 | 10 billion | 6 billion | 1 billion |

Further, the total amount to be maintained by the acquirer bank may be further distributed among various currencies based on at least one of the currency of transaction or the region of the merchant or the region of transaction. In an exemplary implementation of the present invention, one region may consist of several merchants and several card networks operating in that region. Further as disclosed by the present disclosure, the total amount of transaction in a particular region across all networks may be equal to the total number of transactions amount for all the merchants in that region. Further, as disclosed by the present invention, the present method, while predicting the liquidity plan for a particular currency or a region for the given or the forth coming day/s, may further take into consideration the special occasion in the region of a merchant, wherein the special occasion comprises but is not limited to holidays, festivals, discount sale, pay-day, any calendar event, and historical data of a date. A person skilled in the art would appreciate that these parameters are exemplary and do not restrict the disclosure in any possible manner.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and/or “computer-readable storage medium” shall also include any storage medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for smart liquidity management, the method comprising:
receiving, by at least one processor, a past transactional data set comprising data of at least one transaction;
identifying, by the at least one processor, a first set of parameters and a second set of parameters based on the past transactional data set;
analyzing, by the at least one processor, the first set of parameters, to automatically predict an amount receivable for an acquirer bank entity from at least one card network, for a period of time;
analyzing, by the at least one processor, the second set of parameters, to automatically predict an amount payable from the acquirer bank entity to at least one merchant, for the period of time; and
identifying, by the at least one processor, a smart liquidity plan for the acquirer bank entity based on the prediction of the amount receivable and the prediction of the amount payable.

2. The method as claimed in claim 1, wherein the past transactional data set further comprises at least one set of transactional parameters associated with each transaction from among the at least one transaction, wherein the at least one set of transactional parameters comprises an amount, a date, a day of week, occasional event data, a merchant, a currency, and a region.

3. The method as claimed in claim 1, wherein the first set of parameters comprises the at least one card network, a settlement history of a corresponding card network, a currency, a region, and a total transaction amount for the corresponding card network based on at least one from among a date, a day of the week, and a special occasion.

4. The method as claimed in claim 1, wherein the second set of parameters comprises the at least one merchant, a transaction history of a corresponding merchant, a currency, a region, and a total transaction amount for the corresponding merchant based on at least one from among a date, a day of the week, and a special occasion.

5. The method as claimed in claim 1, wherein the smart liquidity plan comprises at least one liquidity deman, wherein each of the at least one liquidity demand corresponds to a specific currency type.

6. A computing device for smart liquidity management, the computing device comprising:
a processor;
a memory; and
a communication interface coupled to each of the processor and the memory,
wherein the processor is configured to:
receive, via the communication interface, at least one past transactional data set comprising data of at least one transaction;
identify a first set of parameters and a second set of parameters based on the received at least one past transactional data set;
analyze the first set of parameters, to automatically predict an amount receivable for an acquirer bank entity from at least one card network, for a period of time;
analyze the second set of parameters, to automatically predict an amount payable from the acquirer bank entity to at least one merchant, for the period of time; and
identify a smart liquidity plan for the acquirer bank entity based on the prediction of the amount receivable and the prediction of the amount payable.

7. The computing device as claimed in claim 6, wherein the at least one past transactional data set further comprises at least one set of transactional parameters associated with each transaction from among the at least one transaction, wherein the at least one set of transactional parameters comprises an amount, a date, a day of week, occasional event data, a merchant, a currency, and a region.

8. The computing device as claimed in claim 6, wherein the first set of parameters comprises the at least one card network, a settlement history of a corresponding card network, a currency, a region, and a total transaction amount for the corresponding card network based on at least one from among a date, a day of the week, and a special occasion.

9. The computing device as claimed in claim 6, wherein the second set of parameters comprises the at least one merchant, a transaction history of a corresponding merchant, a currency, a region, and a total transaction amount for the corresponding merchant based on at least one from among a date, a day of the week, and a special occasion.

10. The computing device as claimed in claim 6, wherein the smart liquidity plan comprises at least one liquidity demand, wherein each of the at least one liquidity demand corresponds to a specific currency type.

11. A non-transitory computer readable storage medium storing instructions for smart liquidity management, the instructions comprising executable code which, when executed by a processor, causes the processor to:
receive a past transactional data set comprising data of at least one transaction;
identify a first set of parameters and a second set of parameters based on the past transactional data set;
analyze the first set of parameters, to automatically predict an amount receivable for an acquirer bank entity from at least one card network, for a period of time;
analyze the second set of parameters, to automatically predict an amount payable from the acquirer bank entity to at least one merchant, for the period of time; and
identify a smart liquidity plan for the acquirer bank entity based on the prediction of the amount receivable and the prediction of the amount payable.

12. The storage medium as claimed in claim 11, wherein the past transactional data set further comprises at least one set of transactional parameters associated with each transaction of the at least one transaction, wherein the at least one set of transactional parameters comprises an amount, a date, a day of week, occasional event data, a merchant, a currency, and a region.

13. The storage medium as claimed in claim 11, wherein the first set of parameters comprises the at least one card network, a settlement history of a corresponding card network, a currency, a region, and a total transaction amount for the corresponding card network based on at least one from among a date, a day of the week, and a special occasion.

14. The storage medium as claimed in claim 11, wherein the second set of parameters comprises the at least one merchant, a transaction history of a corresponding merchant, a currency, a region, and a total transaction amount for the corresponding merchant based on at least one from among a date, a day of the week, and a special occasion.

15. The storage medium as claimed in claim 11, wherein the smart liquidity plan comprises at least one liquidity demand, wherein each of the at least one liquidity demand corresponds to a specific currency type.
